(19) United States
(12) Patent Application Publication
(10) Pub. No.: US 2022/0148352 A1
(43) Pub. Date: May 12, 2022

(54) Predictive Analysis System for Recreational Vehicle

(71) Applicant: Dometic Sweden AB, Solna (SE)

(72) Inventors: Eric Joseph Schuh, Stevensville, MI (US); Paul Argue, Saint Joseph, MI (US); Kavyasri Sriperumbuduru, Saint Joseph, MI (US); Clayton Hendry Meyers, Paw Paw, MI (US); Ulf Landberger, Spanga (SE); Joe Wine, South Bend, IN (US)

(21) Appl. No.: 17/438,034

(22) PCT Filed: Mar. 10, 2020
(86) PCT No.: PCT/IB2020/052066

§ 371 Date: Sep. 10, 2021

Related U.S. Application Data
(60) Provisional application No. 62/816,561, filed on Mar. 11, 2019.

(51) Int. Cl. G07C 5/10; G06N 5/02; G07C 5/08

(52) U.S. Cl. CPC G07C 5/10; G06N 5/02; B60P 3/32; G07C 5/0825; G07C 5/0808

(57) ABSTRACT

Present embodiments relate to utilities, for non-limiting example, water, fuel, power, or remaining waste capacity system for use with a recreational vehicle (RV). More specifically, but without limitation, present embodiments relate to a predictive analysis system for use with the utilities systems of an RV.

### CLAIM TO PRIORITY

This 35 U.S.C. § 371 National Stage Patent application claims priority to PCT Patent Application No. PCT/IB2020/052066, filed Mar. 10, 2020, and titled “Predictive Analysis System for Recreational Vehicle” which claims priority to and benefit of U.S. Provisional Patent Application Ser. No. 62/816,561, filed Mar. 11, 2019 and titled “Predictive Analysis System for Recreational Vehicle”, all of which is incorporated by reference herein.

### CROSS-REFERENCE

Cross-reference is made to U.S. Provisional Patent Application No. 62/816,534, titled “Multiplex Controller Assembly”, filed on Mar. 11, 2019, and U.S. Design patent application Ser. No. 29/683,099, titled “Controller,” also filed on Mar. 11, 2019, all of which is expressly incorporated herein by reference.

### BACKGROUND

### 1. Field of the Invention

Present embodiments relate to water, power, or fuel systems (utilities or resources) for use with a recreational vehicle (RV) which may include marine vehicles. More specifically, but without limitation, present embodiments relate to a predictive analysis system for use with an RV utility systems, for non-limiting example, water, including fresh water and waste tanks, propane and/or power systems.

### 2. Description of the Related Art

In camping scenarios, recreational vehicles (RVs) are outfitted with multiple tanks which may include, but are not limited to, fresh water, gray water, which is generally water which may have been used to wash hands or during a shower, and black water, which may be a combination of water and waste, for example from restroom usage. During the course of the camping trip, a camper must continually monitor the amount of fresh water available for use as well as the fill level of the gray water and the black water tanks. When the fresh water is empty, it must be replenished and when the gray and black water tanks are full, they must be drained for continued use.

It would be desirable for a user to know approximately when the fresh water tank is going to be empty or the gray and black water tanks are going to be full so that the camper may plan ahead to stop at a location where fresh water may be replenished and the gray and black water tanks may be dumped.

Further, during camping trips, the use of propane as well as power also must be monitored so not to run out of power or not run out of propane for cooking, heat, refrigeration or other fuel uses.

Still further, during camping trips, battery power is relied upon when camping off-grid and/or away from shore power. The battery power may be used for various functions, for example lighting, and care should be taken not to run out of battery power during the camping trip.

Likewise, during marine excursions, various water, power, and utility systems may be exhausted. Accordingly, it may be desirable to monitor such characteristics.

Thus it would be desirable to provide this information on a controller which is easily accessible to the user in order to render the information easily accessible, without having to visually inspect the tank conditions. It would also be desirable to provide some predictive analysis of the tank conditions so that a user can plan ahead for stoppage along a camping trip in order to fill or dump tanks as needed.

The information included in this Description of Related Art section of the specification, including any references cited herein and any description or discussion thereof, is included for technical reference purposes only and is not to be regarded subject matter by which the scope of the invention is to be bound.

### SUMMARY

The present application discloses one or more of the features recited in the appended claims and/or the following features which alone or in any combination, may comprise patentable subject matter.

Present embodiments relate to a predictive analysis system for recreational vehicles, which may be utilized with the water or power system or other utilities in order to provide a camper or boater with a predictive time frame for a need to either replenish a fresh water tank or dump gray or black water tanks or other utilities. The predictive analysis system analysis sensor data and learns, based on pattern analysis, how much of a utility is being used over a period of time. The predictive analysis system may then predict based on the learning when a utility will be fully utilized or otherwise unusable. Further, the predictive analysis system may be utilized with the power system in order to provide an estimated use time the battery power for the camper. Likewise, the predictive analysis system may be used to estimate the amount of propane remaining, or alternatively, the amount of fuel left for a generator so that the camper can refill before running out of engine fuel, for example on a boat. The predictive analysis system may provide a graphical representation to the user of a date by which the tanks need to be either re-filled or emptied.

According to some embodiments, a method of predicting availability of a utility for an RV or boat, may comprise providing the recreational vehicle with at least one utility having a measurable value related to utility usage or remaining utility available for use, obtaining utility sensor inputs from the at least one utility onboard the RV, analyzing the sensor inputs, and, providing an output which predicts when the utility will no longer be usable.

According to some optional embodiments, the utility may be exhausted over a period of time. For example, the utility may be power, water, or fuel. In other embodiments, the utility may be storage space.

According to some embodiments, a method of predicting fluid usage, comprise at least one tank having a sensor to detect a fluid level within the at least one tank, analyzing the sensor data over multiple time periods, learning, based on the analyzing, the amount of fluid used during the time period, predicting when the at least one tank will either require filling, or require emptying, and displaying a predicted result to a user on a controller.

According to some optional embodiments, the following options may be performed with the methods alone or in combinations. The method may further comprise utilizing a daily use approach for learning fluid usage.

The daily use approach may analyze the total usage over a daily period.

The method may comprise utilizing an averaging approach for learning fluid usage. The method may further comprise determining an average amount of water used.

The method may further comprise utilizing a neural networking approach for learning fluid usage. The neural network approach may further comprise utilizing a plurality of input factors in a neural network in the predicting. The input factors may include at least two of: outside temperature, outside humidity, inside temperature, inside humidity, geographic location, location of nearest fill/dump site, planned activity, hours awake, number of people on the trip, calendar inputs indicating need for shower, personal behavior of said user, diet, or health problems.

The displaying may have a graphical representation. The method may further comprise displaying a time or a date wherein the at least one tank will require servicing. The method may further comprise applying a correction factor before the predicting.

According to some embodiments, a method of predicting availability of a utility comprises the steps of obtaining a utility sensor input from the utility; analyzing the sensor input from the utility, providing a graphical display predicting when the utility will be exhausted and one of: (i) suggesting a change in utility usage settings to prolong usage time, or, (ii) automatically changing utility usage settings based on said suggesting or based on a selected extension of time period.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. All of the above outlined features are to be understood as exemplary only and many more features and objectives of the various embodiments may be gleaned from the disclosure herein. Therefore, no limiting interpretation of this summary is to be understood without further reading of the entire specification, claims and drawings, included herewith. A more extensive presentation of features, details, utilities, and advantages are provided in the following written description of various embodiments, illustrated in the accompanying drawings, and defined in the appended claims.

### BRIEF DESCRIPTION OF THE DRAWINGS

In order that the embodiments may be better understood, embodiments of a predictive analysis system will now be described by way of examples. These embodiments are not to limit the scope of the claims as other embodiments of a predictive analysis system will become apparent to one having ordinary skill in the art upon reading the instant description. Non-limiting examples of the present embodiments are shown in figures wherein:

FIG. 1 is a perspective view of a recreation vehicle (RV) which shows various illustrative systems for which predictive analysis may be utilized;

FIG. 2 is a perspective view of a fluid tank with a fluid level sensor;

FIG. 3 is a perspective view of a controller and display;

FIG. 4 is a view of a predictive analysis display for a fresh water tank;

FIG. 5 is a view of a predictive analysis display for a gray water tank;

FIG. 6 is a view of a predictive analysis display for a black water tank;

FIG. 7 is a schematic view of a neural network;

FIG. 8 is a view of a predictive analysis display for a battery (power) system; and,

FIG. 9 is an example computer system.

### DETAILED DESCRIPTION

It is to be understood that a predictive analysis system is not limited in its application to the details of construction and the arrangement of components set forth in the following description or illustrated in the drawings. The described embodiments are capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

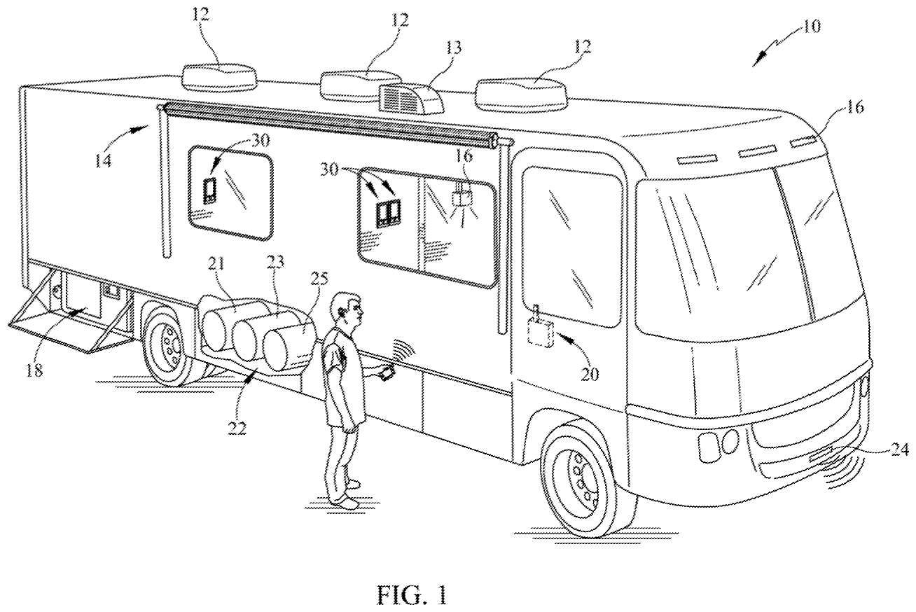

Referring now to FIGS. 1-9, a predictive analysis system is provided for recreational vehicles (RV) use including marine craft, which may be utilized to provide predictive analysis of both the fluid usage and fluid and waste storage by a camper as well as the stored power usage or propane usage for non-limiting example. The fluid usage may include, but is not limited to, fresh water usage or filling of gray and black water tanks. The embodiments analyze data and provide information relating to the anticipated date when the fluid tanks will either need to be filled or dumped. Further, the power analysis may provide a user a predictive date and/or time at which the camper will likely need to connect to shore power or otherwise recharge the batteries of the RV in order to continue off grid camping. The consumption of resources can be predicted over a period of time based on usage patterns, environmental conditions, weather forecasts and the like. The predicted resource consumption may be used to: (i) suggest actions to make the resource last longer, (e.g. change temperature settings for AC, optimize vehicle placement for solar charging, increased shadow, etc.); (ii) automatically change settings to increase stay (using the same recommendations for example); or (iii) automatically change setting toward a target expressed in prolonged stay (i.e. the user may select how many more days she wants the resource to last and the system changes settings to achieve that goal).

Referring now to FIG. 1, a schematic view of an RV 10 is depicted. It should be understood that although an RV 10 is shown as a drivable vehicle, the term “RV” is not limited to drivable vehicles. The term “RV” is also meant to include towable structures, sometimes also called campers, as well as boats or other marine applications, for example which use canopy structures which may or may not be retractable, commercial vehicles, agricultural vehicles, horse trailers, and temporary structures such as those used at sports events, (tailgating), flea markets. Further, the term “RV” may be inclusive of fixed structures such as homes, cabins or commercial structures, all of which may utilize a predictive analysis system.

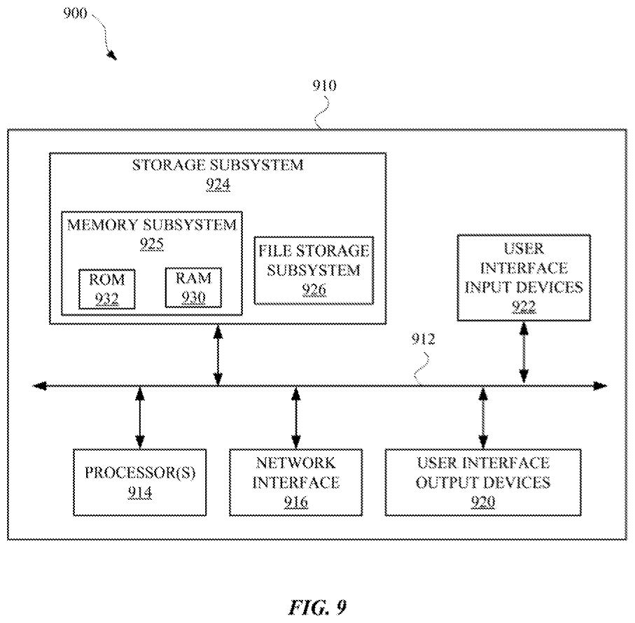

The figure shows an RV 10 and a plurality of mechanical systems which are operably connected to the RV 10 and which render the camping activities more enjoyable. For example, the systems may include, but are not limited to, heating ventilation and air conditioning (HVAC) 12 which uses electrical power, an awning system 14, a lighting system 16, an electrical system 18, a fresh water and/or waste water system 22, and/or other systems. This list is not exhaustive and various others may be utilized. Each of these systems may comprise a set of controls which may be controlled by a controller 30. However, for purposes of discussion, these controls allow for operation of the various systems of the RV 10 and allow for a user to operate the various functions of the RV 10 from one or more locations within the RV 10. The controller 30 can embody, include, and/or be in communication with, one or more computer systems, such as the computer system 910 set forth in FIG. 9. Likewise, it should be understood that these systems or utilities may also be applicable to marine use in various forms and such controller may be utilized in accordance with this teaching.

In accordance with the instant embodiments, the following brief description of the functions is provided with regard to some of the systems being controlled by a controller 30, for purpose of understanding the predictive analysis function.

The HVAC system 12 may include air conditioning equipment and heating devices which are illustratively, but not in a limiting manner, shown on the roof of the RV 10. The HVAC system 12 may utilize stored power of a battery, engine power, solar power, shore power, and also may also utilize propane which may be stored with a fixed amount on the RV 10. The HVAC system 12 may additionally include ventilation device, such as a roof fan 13 which may be used alone to vent the RV 10, or may be used in combination with the HVAC to more quickly cool the RV 10, for example in the summer when the RV 10 has been sitting for some time in the sun and the cooling system has been off.

Additionally, the RV 10 may include an awning system 14 which may include one or more awnings which create a shaded area adjacent to the RV 10 and/or over windows of the RV 10. The awning system 14 may be powered by the stored battery power onboard the RV 10 and as part of the power system 18. The RV awning(s) system 14 may be roller tube or cassette type awnings, for non-limiting example. The awnings system 14 may be controlled from the controller 30 for ease of extension or retraction from the interior of the RV 10. In some embodiments, additional awnings may be provided for individual windows, for example.

Additionally, some RVs may comprise slide out portions to expand the interior size of the RV 10. Controls may be provided to adjust the position of the side out (not shown).

In still additional embodiments, the RV 10 may include lighting 16, interior and/or exterior, which provides desired illumination. The lighting 16 may also work with the stored battery power onboard the RV 10. The illumination may be along walls of the RV 10, on or about the awning, about the entry ways to the RV 10 and may be segregated by room within the RV 10. Lights may be added at any of various locations and power control of these may be provided by the controller 30. Still further, it may be also desirable to provide additional control of lighting effects. For example, some lights may be able to be dimmed in addition to powered on and off. Further, some lights may be able to be color controlled, any of these being desirable to create a mood within or about the exterior of the RV 10.

Still further, the RV 10 may include one or more generators as a power or electrical system 18. For example, the electrical system may have a generator which can be started by control of the controller 30. The controller 30 may also include information on the status of the electrical system such as fuel level for the generator, which may be gas or propane, and/or charge levels for batteries in the RV 10. Or the controller 30 may provide power usage levels for the systems onboard the RV 10. Further, the electrical system 18 may include the capability to detect and/or switch to shore power when detected.

The RV 10 may also comprise a water system 22 which may include multiple tanks. For example, the water system 22 may include, in some embodiments, at least one each of a fresh water supply tank 21, a gray water tank 23 and a black water tank 25. The fluid levels for many of these tanks may be provided to the user by the controller 30. Still further, as will be described further, it may be desirable to provide some predictive information on tank levels to inform a user when the fresh water may be empty, or nearing empty, or when the gray and black water tanks may be filled or near filled.

Still more systems may be controlled by the controller 30. For example, in some embodiments, the locks and/or an alarm systems 20, 24 may be controlled.

Also shown in the RV 10 are controllers 30 which may be located in various locations of the RV 10. This is convenient for grouping controls, for the room where the controller 30 is located. The controllers 30 may have some desired control functions in a bathroom, different control functions in a bedroom, and still other desired functions in a galley for example. Still further, in some rooms, for example the galley, it may be desirable to have more functions available to the user. For example, it may be desirable to lock and alarm the RV 10 near the entry/exit door of the RV 10. Further, it may be desirable to have control function of the awning system 14 and the HVAC system 12. The controllers 30 also allow for monitoring of the various system capacities at various locations. For example, it may be desirable to have one location within the RV 10 with a controller with all system utilities monitored. Alternately, it may be desirable to provide a controller in a bathroom where tank levels are pertinent, or perhaps a location in the RV 10 near the power system 18, to monitor battery conditions. Further, in some embodiments, multiple controllers 30 may have access to the utilities information so that it may be displayed wherever desired within the RV 10.

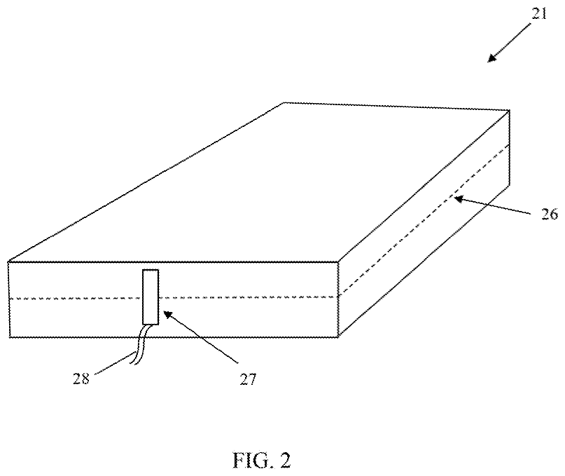

Referring to FIG. 2, an illustrative tank 21 is depicted in a perspective schematic view. The tank 21 may be any of the fresh water, gray water, or black water tanks depicted schematically in FIG. 1. Further, the tank 21 is shown as a three-dimensional quadrilateral but various shapes may be utilized. The shape of the tank of FIG. 2 is depicted as differing from the tank shapes of FIG. 1 merely to depict that other shapes may be utilized. The shape of the tank 21 may be dependent upon the architecture of the RV 10 and the location of the tank at issue and therefore is not limiting. For purposes of description, the instant tank 21 of FIG. 2 will be referred to as a fresh water tank but one skilled in the art should realize that any of the fresh water, gray water or black water tanks are capable of being utilized with the predictive analysis system in order to determine when the tank needs to be filled with fresh water or the gray or black water needs to be emptied from the tank.

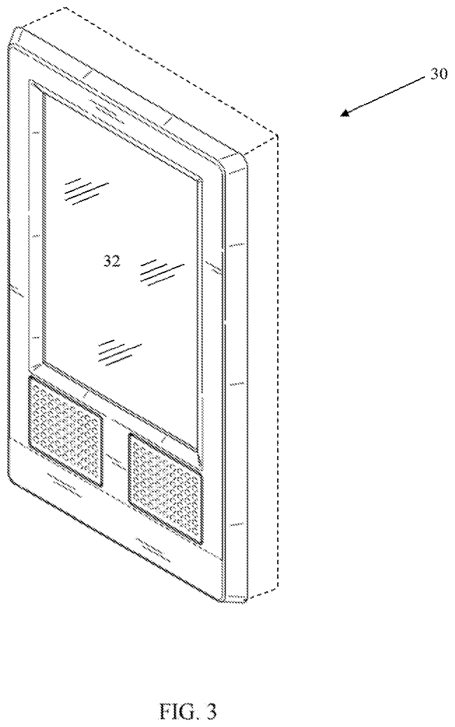

The instant tank 21 is shown with some level of water 26 indicated by broken line along the boundary surfaces of the tank 21. Also shown in FIG. 2 is a sensor 27 which is positioned on a side wall of the tank 21. The sensor 27 includes at least one wire 28 extending from the sensor 27 in order to provide a signal to the controller 30 (FIGS. 1 and 3). In other embodiments the sensor 27 may also wirelessly communicate to the controller 30. The sensor 27 detects a fluid level for the tank 21 and provides a signal to the controller 30 as to the instantaneous level of the fluid therein. Over a period of time, the various fluid levels may be recorded in a database to monitor the level of decrease of fluid in the tank 21 or the level of increase of fluid in the tanks 23, 25 during the period of time. The database can be stored by one or more non-transitory computer readable storage mediums that are accessible to the controller 30. In some implementations, the database can be stored in a memory of the controller 30 and/or accessible to the controller 30 via a network (e.g., the internet). The sensor 27 may be a capacitive sensor or may be an inductive sensor in some embodiments. In some other embodiments, a float type sensor may be used. Further, since other systems may be monitored, other sensor types may also provide input to the predictive analysis system, for example a current probe or a shunt or clamp for voltage detection.

Referring now to FIG. 3, a perspective view of an illustrative controller 30 is depicted. The controller 30 includes a display 32 which provides information to the user about the condition or status of the tanks, as well as the anticipated time period at which the tanks will either be empty or will need to be emptied. The controller 30 may be in communication by direct wire to the sensors of the various tanks 21, 23, 25 (FIG. 1), or alternatively, may be in wireless communication therewith. The controller 30 may be in communication with any sensors of any of the systems being monitored for predictive analysis, for example the propane level, the stored battery power of power system 18. The controller 30 has various features also described in U.S. Design patent application Ser, No. 29/683,099, filed Mar. 11, 2019, all of which is incorporated by reference herein.

The controller 30 can store and/or operate according to one more computer programs directly related to the predictive analysis of the data being input from the sensors, for example sensor 27. The analysis may log data from a specific sensor multiple times over a period of time and generate a database from which further data may be extrapolated to predict a time upon which the program anticipates that the fresh water tank 21 may need to be filled or the gray and black tanks 23, 25 may need to be pumped out. It should be understood that each system or utility may have one or more sensors measuring data that may be logged.

The controller 30 may have various features either onboard or providing input. The controller 30 may include a microcontroller or processor, memory, RV-C and Bluetooth and Wi-Fi communication standard, Air conditioning communication standard for example serial, audio amplifier and speaker or buzzer, a microphone, humidity and temperature sensor, ambient light or proximity sensor, real time clock, battery and holder, a touch screen display 32 such as, for example an LCD or LED, and a power supply, and other mechanical or electrical connections and connectors.

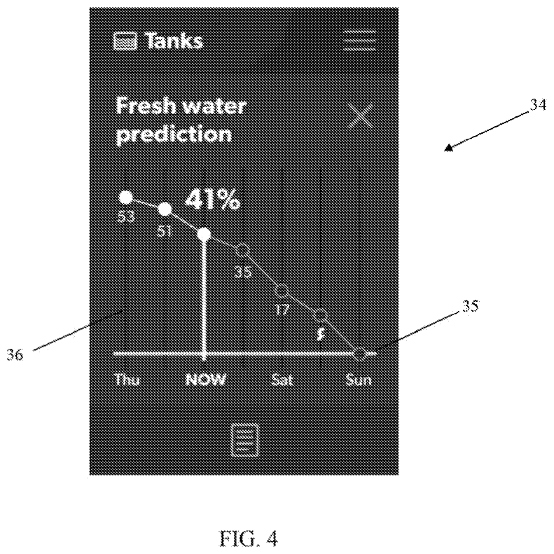

Referring now to FIG. 4, a sample control screen shot 34 is depicted. The screen shot 34 is provided by way of an example of the predictive analysis for the fresh water tank 21 (FIG. 1) of the RV 10 (FIG. 1). As depicted, a graphical representation shows along one axis 35 a plurality of dates or days inclusive of the predictive time period and the prior time period of use. On the other axis 36 is a percentage of fresh water remaining in the tank 21. As one skilled in the art will understand, in review of a fresh water tank 21, it is desirable that the fresh water system be predictive about when the fresh water supply in the tank 21 will be exhausted. Thus, as shown in the illustrative FIG. 4, the time period extends over a number of days, for example four days, and the percentage of water is depicted a day before the current date and two days after the current date. These time periods may be adjusted but a portion of the analysis is predictive so that the date of the water supply being exhausted is anticipated and depicted. Additionally, as an alternative to percentage, a value, for example gallons, may be depicted. Likewise, other formats of graphical representation may be used. For example, a tank may be shown with day/date depicting anticipated empty or a bar graph showing anticipated empty day/date.

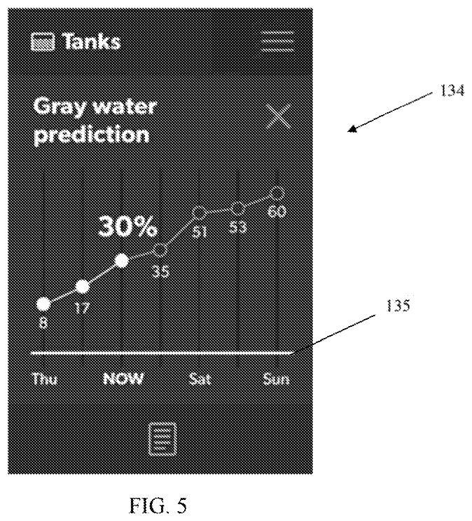

With reference now to FIG. 5, an illustrative analysis of the gray water tank 23 (FIG. 1) is provided by way of screen shot 134. One skilled in the art will understand that the gray water tank 23 fills for a period of time during a camping or boating excursion. Accordingly, a predictive analysis program corresponding to the screen shot 134 can monitor at least one sensor on the gray water tank 23 and render a depiction (e.g., via a graphical display panel) of the increase in the contents (level 136) of the gray water tank 23 over a period of time 135, which is disposed along the lower axis of the graphical representation. In the instant embodiment, for example, a four day period is shown and during that period, the increase in the tank contents is shown such that at the last dates of the graphical representation, the content amounts of the gray water tank 23 are predicted.

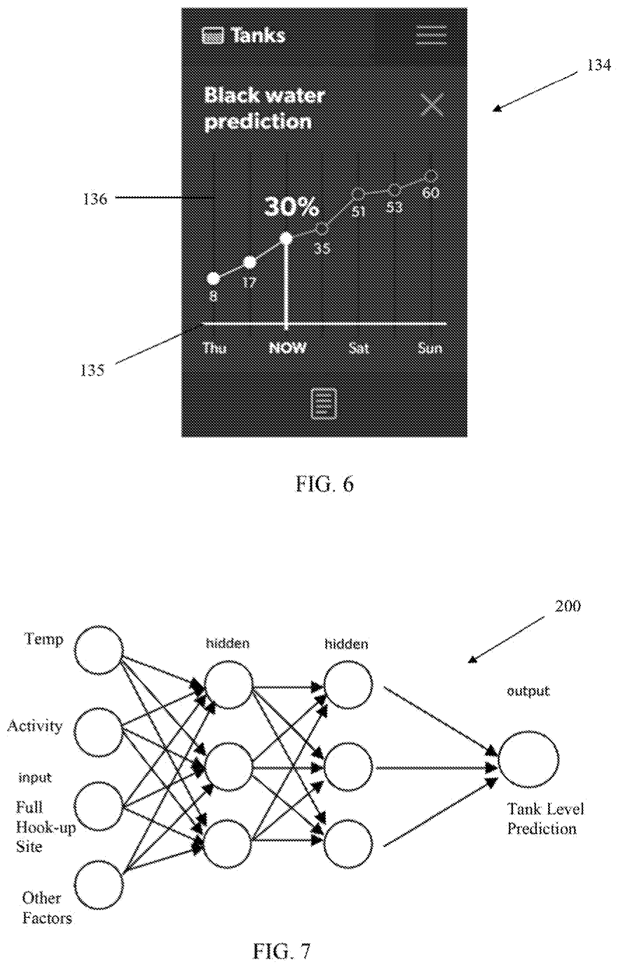

With reference now to FIG. 6, graphical representation of a predictive analysis for the black water tank 25 (FIG. 1) is also provided. As with the gray water tank 23, the black water tank 25 may also start out empty, or with a small amount of fluid, during a camping excursion and fills over a period of time during usage. The screen 134 provides a time period 135 on one axis and a level percentage 136 on the other axis. The graphical representation shows that over a period of time, the level of fluid in the tank 25 starts out relatively low and increases during the period of time. The graphical representation shows a predictive period over the last two days and the rate at which the black water tank 25 is anticipated to fill.

The predictive analysis may occur in various manners. Three illustrative embodiments are provided as methods by which the predictive analysis may occur within a program of the controller 30. Each of these embodiments provide for analyzing data from sensors, local to any utilities and may include data gathered for example via internet or cloud databases. The system learns by pattern analysis of the data being gathered and stored, and subsequently can predict future utility usage or availability based on the learning which occurs. According to one method, an averaging approach may be utilized to make a determination of how much utility service, for example water, propane, or electricity, is being used on average. According to another embodiment, a neural network approach may be utilized to train a model on parameters which may result in desired usage determination. In further embodiments, a daily use approach may be utilized.

Starting with the daily use approach of analyzing, and for example relative to the tank systems, the controller software may utilize the sensors 27 at each tank 21, 23, 25 to determine how much water is used each day. The sensor data may be stored in memory for each of the tanks, battery, propane levels, or other characteristics being monitored. Upon determination of each such daily uses, a line may be created between each adjacent daily data point. Optionally, more than one data point may be determined for each day. For purposes of prediction, the rate of use is extrapolated out over a period of time to make a determination as to when the tanks will either be filled or will be empty, or for example, when the stored battery power of the power storage system 18 will be exhausted. As an example, if a user takes a shower on Monday, Wednesday, and Friday, or for example three days a week, the software can learn which usage rate applies to a given user, or a group of users. This daily use approach may require several days of data before it can accurately predict usage. In some embodiments, it may require a full week to begin making predictions. However, such actual use data may also be compared with predictions to improve long term averages and provide more accurate results. Further, it should be understood that additional data may be utilized with the usage data in order to provide correction factors. For example, it may be that the program determines that additional water is used once the ambient temperature drops below a certain number or temperature. Thus, when the ambient temperature reaches such value, a correction factor may be applied to the predictive analysis results so that a more accurate predictive result is provided to the user.

In another analyzing approach, the averaging approach, one or more computer programs can utilize output from one or more sensors on the tanks 21, 23, 25, or for any pertinent system, to determine how much water is being used on average during a period of time. This approach would keep the start time of the camping trip or boat excursion, when the tanks were at their optimal value, for example near full or empty, and use the current time to determine the average tank usage during that period. One or more measurements may be taken during such time period, for example each day, and stored in a memory or lookup table. The predictive analysis system could also store a history of how long a tank lasted in prior excursions to better predict future averages. Once the grey/black water tanks are emptied or once a fresh water tank is filled the averaging would start over for that tank. Over multiple uses, the collected values can also be averaged to further optimize the prediction. Other factors can also be reviewed such as how long a tank lasted at different ambient temperatures, for example 80 degrees F. vs. 60 degrees F. Those averages can be stored so that on a 60 degree F. day versus an 80 degrees day, that average number can be used to predict tank life which optimization for ambient temperature. Other factors may also be considered with data saved related to such factor. Over the period of time of use and data gathering, the averaging approach may become more accurate than the daily use approach and as with the daily use approach, the averaging approach may require several days or more to begin making predictions which have some valued response.

Also, as the previously described daily use approach, a correction factor may be applied when other conditions are met such as increased usage at or below a specific temperature, for example. Other factors may be applied to the usage in order to provide a more accurate result via such correction factor.

In a third analyzing approach, referred to herein as a neural network approach, a neural network 200 may be trained on various parameters of the RV such that by review and application of those various factors, an accurate prediction of the use of water or the filling of gray or black water tanks may be provided, or prediction of usage of other utilities. The following inputs could be collected and used to train a neural network such as an artificial neural network or a recurrent neural network. Such various input factors include, but are not limited to, outside temperature, outside humidity, inside temperature, inside humidity, geographic location, location of a close water fill up station, planned activities for the day, hours awake, the number of people and/or animals on the trip, calendar inputs that may indicate need for a shower, the proximity of full hook-up sites (inclusive of water fill, fluid dump, or electric hook-ups), personal behavior, diet, and/or health problems. With brief reference to FIG. 7, various exemplary neural network nodes are depicted schematically which may be utilized to provide inputs to the neural network or to make a determination.

Further, the data input to the neural network could be local or could be provided by way of cloud/internet connection, either from the RV or from a smart device with data connection. Data could be collected for all users using this predictive analysis system and it would be uploaded to a cloud-based database. This data would be the sensor values of the system but also data that may not come from other inputs. By providing global positioning of the RV, and utilizing known databases, for example local weather database at the position of the RV 10, such data could be input to the neural network 200. All of this data would be collected and the neural network 200 would be trained to provide a weighted value of each of various factor. Those new weighted values would be downloaded to each RV 10 with this predictive analysis system so that the system is continually improving.

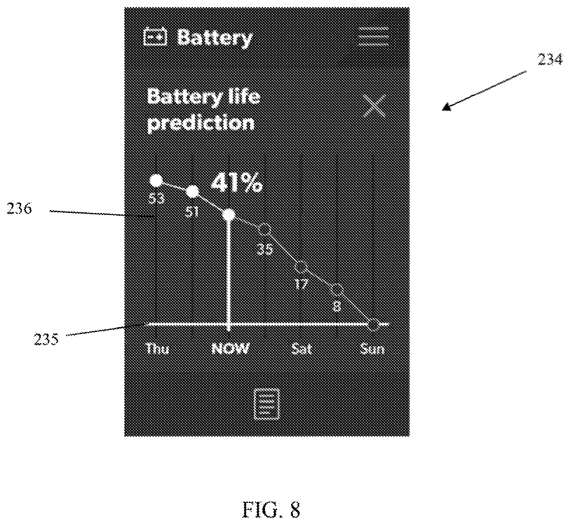

With brief reference to FIG. 8, one skilled in the art should also understand that the predictive analysis may also be applied to utilities other than the fluid levels of the tank system 22 (FIG. 1). In some embodiments, the camping may require off grid usage of battery power and it would be desirable to make a determination when the batteries will be exhausted before needing a recharge. Accordingly, as depicted in FIG. 8, the controller screen shot 234 is depicted for prediction of battery life. For example, the instant embodiment provides a number of days along one axis 235 of the graphical representation. The battery level is shown in the second axis 236 as a percentage of the life available in the battery along second axis 236. As mentioned in the instant embodiment, the battery life is shown at 53% on a first day and on the next day, is shown at 41%. Beyond the instant day, the graphical representation provides a predictive analysis of where the battery percentage will be over the next 48 hour period. This predictive battery life may be determined in any of the approaches previously described, for example the daily use, the averaging approach or the neural network approach. Thus, a user may have a predictive time period by which the camping trip should be ended or alternatively, the camper relocated to a location with grid or shore power available for charging of the batteries. Alternatively, such information may be utilized by the user if solar power is available so as to turn the solar charging system on and allow for additional power to be stored in the batteries in such manner. As with previous descriptions, other environmental factors may be input to improve or optimize the system. For example, the outside temperature may be factored into battery power since one skilled in the art will realize that battery storage capacity may decrease at lower temperatures. Thus curves could be provided for predicted battery storage at a first temperature and a second temperature.

Still further, one skilled in the art should realize that various systems may have an effect on other systems. For example, when the awnings are extended, windows of the RV 10 may be covered which may result in cooler interior of the RV 10 and therefore cooler temperatures in the summer and less power usage by the HVAC system 12. Accordingly, for non-limiting example, the system 12 could also extend the awning or close blinds to limit the amount of heat in the RV 10 to further extend the stored battery power that is remaining. The predictive analysis system may also analyze and determine which system uses less energy to operate—the awning/blinds or the heat rise of the current day based upon current conditions (cloudy vs sunny).

In another example of interaction of the systems, the lighting system 16 may be adjusted in order to preserve stored battery power. For example, the user could set a stored battery threshold wherein the lights go into a power save mode. For example once the stored battery power or energy drops to some value, for example 10%, the lighting system 16 may dropped to 20% of their full brightness. This may extend the life of the stored battery power or energy.

In some embodiments, the data provided by the predictive analysis may be used by the camper or to notify a service provider, as a means for improving the camping experience. For example, at some campsites, service providers may perform tasks such as re-filling fresh water tanks or alternatively empty gray and black water tanks. In some embodiments, the predictive data may be provided to a service provider at a campsite so that the service provider may contact the camper and set up an appointment to either fill or empty respective tanks. Alternatively, the data may also be sent as a reminder to a camper's smart device, or displayed on the controller 30, to contact a service provider about filling or emptying appropriate tanks. This may be more helpful if a camper wants to control communications outbound from the RV 10, or alternatively if a camper is not staying at a commercial campsite and therefore needs to determine what service provider to contact.

Further, the predictive analysis system may be programmable to personalize for a trip, a user or a group of users for example. In some embodiments, the controller 30 may provide functionality such as a vacation planning wizard. Such wizard may for example all a user to set a vacation profile for the utilities, such as the amount of showers in a week and an alarm if a specific user or the group exceeds their water usage. The alarm could be audible or it could be flashing the bathroom light when they pass 2 gallons of water. This alarm would be displayed or heard on the controller 30, or via communication to smart devices.

FIG. 9 is a block diagram 900 of an example computer system 910, which may be on the controller 30 or may include the controller 30 as well as other hardware. Computer system 910 typically includes at least one processor 914 which communicates with a number of peripheral devices via bus subsystem 912. These peripheral devices may include a storage subsystem 924, including, for example, a memory 925 and a file storage subsystem 926, user interface output devices 920, user interface input devices 922, and a network interface subsystem 916. The input and output devices allow user interaction with computer system 910. Network interface subsystem 916 provides an interface to outside networks and is coupled to corresponding interface devices in other computer systems. Such network interface may also include, but is not limited to wired and wireless communications for local communications as well as communication with cloud based databases and storage, as well as communications to smart devices at or near the RV 10, such as for non-limiting example Bluetooth and Wi-Fi connections, but also may include other communication systems like RV-C.

User interface input devices 922 may include a keyboard, pointing devices such as a mouse, trackball, touchpad, or graphics tablet, a scanner, a touchscreen incorporated into the display, audio input devices such as voice recognition systems, microphones, and/or other types of input devices, such as inputs at the controller 30 and sensors at the various RV systems. In general, use of the term “input device” is intended to include all possible types of devices and ways to input information into computer system 910 or onto a communication network.

User interface output devices 920 may include a display subsystem, a printer, a fax machine, or non-visual displays such as audio output devices. The display subsystem may include a cathode ray tube (CRT), a flat-panel device such as a liquid crystal display (LCD) or light emitting diode (LED) display, a projection device, or some other mechanism for creating a visible image. The display subsystem may also provide non-visual display such as via audio output devices. In general, use of the term “output device” is intended to include all possible types of devices and ways to output information from computer system 910 to the user or to another machine or computer system.

Storage subsystem 924 stores programming and data constructs that provide the functionality of some or all of the modules described herein. For example, the storage subsystem 924 may include the logic to perform selected aspects of any programs, processes, claims, and/or steps discussed herein, and/or to implement one or more features of RV 10, controller 30, neural network(s), graphical user interfaces, and/or any other apparatus and/or module discussed herein.

Present embodiments use machine learning based predictions, which may or may not be additionally used with online learning algorithms. The machine learning will be tailored one time for each vehicle in various situations. The predictive analysis system will adapt to new conditions, locations, climates, and the like, any of which may change consumption of resources. The model or system will also adapt to specific users and adapt to vehicles, vehicle changes, or equipment changes, for example upgrade to Air conditioner and the like, and associated new usage patterns.

These software modules are generally executed by processor 914 alone or in combination with other processors. Memory 925 used in the storage subsystem 924 can include a number of memories including a main random access memory (RAM) 930 for storage of instructions and data during program execution and a read only memory (ROM) 932 in which fixed instructions are stored. A file storage subsystem 926 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 926 in the storage subsystem 924, or in other machines accessible by the processor(s) 914.

Bus subsystem 912 provides a mechanism for letting the various components and subsystems of computer system 910 communicate with each other as intended. Although bus subsystem 912 is shown schematically as a single bus, alternative implementations of the bus subsystem may use multiple busses.

Computer system 910 can be of varying types including a workstation, server, computing cluster, blade server, server farm, or any other data processing system or computing device. Due to the ever-changing nature of computers and networks, the description of computer system 910 depicted in FIG. 9 is intended only as a specific example for purposes of illustrating some implementations. Many other configurations of computer system 910 are possible having more or fewer components than the computer system depicted in FIG. 9.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the invent of embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases.

Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

The foregoing description of methods and embodiments has been presented for purposes of illustration. It is not intended to be exhaustive or to limit the invention to the precise steps and/or forms disclosed, and obviously many modifications and variations are possible in light of the above teaching. It is intended that the scope of the invention and all equivalents be defined by the claims appended hereto.

1. A method of predicting availability of at least one utility for a recreational vehicle (RV), comprising:
providing said RV with the at least one utility having a measurable value related to utility usage or remaining utility available for use;
obtaining a utility sensor input from the at least one utility onboard the RV;
analyzing the utility sensor input; and,
providing an output which predicts when the utility will no longer be usable.

2. The method of claim 1, wherein the at least one utility is exhausted over time.

3. The method of claim 1, wherein the at least one utility is power, water, fuel, or storage space.

4. A method of predicting fluid usage, comprising:
at least one tank having a sensor to detect a fluid level within said at least one tank;
analyzing sensor data of the sensor over multiple time periods;
learning, based on the analyzing, an amount of fluid used during the time periods;
predicting when the at least one tank will either require filling, or require emptying;
displaying a predicted result to a user on a controller.

5. The method of claim 4 further comprising utilizing a daily use approach for learning fluid usage.

6. The method of claim 5 wherein said daily use approach analyzes the fluid usage over a daily period.

7. The method of claim 4 further comprising utilizing an averaging approach for learning fluid usage.

8. The method of claim 7 further comprising determining an average amount of water used.

9. The method of claim 4 further comprising utilizing a neural networking approach for learning fluid usage.

10. The method of claim 9 further comprising utilizing a plurality of input factors in a neural network in said predicting.

11. The method of claim 10, said plurality of input factors including at least two of:
a. outside temperature;
b. outside humidity;
c. inside temperature;
d. inside humidity;
e. geographic location;
f. location of nearest fil/dump site;
g. planned activity;
h. hours awake;
i. number of people on a trip;
j. calendar inputs indicating need for shower;
k. personal behavior of said user;
l. diet; and,
m. health problems.

12. The method of claim 4 further wherein said displaying having a graphical representation.

13. The method of claim 11 further comprising displaying a time or a date wherein said at least one tank will require servicing.

14. The method of claim 4 further comprising applying a correction factor before said predicting.

15. A method of predicting availability of a utility, comprising:
obtaining a utility sensor input from the utility;
analyzing the utility sensor input from the utility;
providing a graphical display predicting when the utility will be exhausted; and,
one of:
suggesting a change in utility usage settings to prolong usage time; or,
automatically changing utility usage settings based on said suggesting or based on a selected extension of time period.
